(19) United States
(12) Patent Application Publication
(10) Pub. No.: US 2017/0111828 A1
(43) Pub. Date: Apr. 20, 2017

(54) METHOD AND APPARATUS FOR IMPROVING CIRCUIT-SWITCHED FALLBACK IN A WIRELESS COMMUNICATIONS SYSTEM

(71) Applicant: MediaTek Inc., Hsin-Chu (TW)

(72) Inventor: Shang-An TSAI, Taipei City (TW)

(21) Appl. No.: 14/884,968

(22) Filed: Oct. 16, 2015

(51) Int. Cl. H04W 36/00; H04W 76/06; H04W 76/00

(52) U.S. Cl. CPC H04W 36/0022; H04W 76/007; H04W 76/068

(57) ABSTRACT

A method for improving circuit switched fallback for a user equipment (UE) in a wireless communications system, herein the UE is capable of communicating via first and second radio access technologies (RATS), including: determining that a connection has been released, wherein the connection is associated with a second network corresponding to the second RAT; starting a timer providing a period of time when the connection has been released; and stopping e timer after a condition is satisfied.

### BACKGROUND OF THE INVENTION

Field of the Invention

Aspects of the present invention relate generally to wireless communications and, more particularly, to a method and an apparatus for improving Circuit-switched fallback (CSFB).

Description of the Related Art

Third Generation Project Partnership (3GPP) Long Term Evol on (LTE) is often marketed as “4G” and represents the latest standard for wireless communications networks. LTE utilizes an Internet Protocol (IP) Multimedia Subsystem (IMS) framework, which leverages packet-based signaling. However, LTE also offers support for previous technologies (marketed as “2G” or “3G”), such as Universal Mobile Telecommunications (UMTS) platforms, Global System for Mobile Communications (GSM) platforms, and Code Division Multiple Access (CDMA) platforms, which utilize a different air interface than LTE and can operate according to circuit switching technology rather than packet-based technology.

For example, LTE allows a circuit switched fall back (CSFB) procedure, in which an LTE handset can leverage existing infrastructure of previous 2G or 3G technologies to make or receive a voice call. In other words, the LTE handset can drop an existing LTE connection with an LTE evolved Node B (eNB) and fall back to a 2G or 3G cell (e.g., Node B or base station). Upon completion of the call, the LTE handset can then re-establish a connection with the LTE network.

However, there may be instances where the CSFB procedure may fail. For example, a communications apparatus may not be moved from the LTE network to the 3GPP CS network for some reason. The reason may be among the following causes: (1) the 3GPP CS network does not complete the development of the access technology; (2) the 3GPP CS network expects the communications apparatus to finish the location updating procedure and completely set up the call; (3) the 3GPP CS network is temporarily not functioning; or (4) the communications apparatus has already released the call (i.e., a MO call is released).

When the communications apparatus directly switches from the 3GPP CS network to the LTE network, the MT/MO call cannot be connected and a ping-pong effect may occur. Due to the ping pong effect, the communications apparatus will be moving between the LTE network and the 3GPP CS network quite frequently.

Therefore a method and an apparatus for improving circuit-switched fallback between different RATs are proposed to solve the problems described above.

### BRIEF SUMMARY OF THE INVENTION

A detailed description is given in the following embodiments with reference to the accompanying drawings.

A method and an apparatus for improving circuit-switched fallback are provided.

In a preferred embodiment the invention is directed to a method for improving circuit-switched fallback for a user equipment (UE) in a wireless communications system, wherein the UE is capable of communicating via first and second radio access technologies (RATs), comprising: determining that a connection has been released, wherein the connection is associated with a second network corresponding to the second RAT; starting a timer providing a period of time when the connection has been released; and stopping the timer after a condition is satisfied.

In some embodiments, the condition belongs to one of the following: detecting that a call is successfully connected; or detecting that the UE successfully goes back to a first network corresponding to the first RAT. In some embodiments, the call is a mobile terminating (MT) call or a mobile originating (MO) call. In some embodiments detecting that the UE successfully goes back to the first network is performed through a procedure, wherein the procedure is a handover procedure, a cell change order procedure, a redirection procedure, or a cell reselection procedure. In some embodiments, the method further comprises: detecting that the timer has expired and the condition is not satisfied; checking whether the UE needs to stay in the second network after the timer has expired; and going back from the second network to a first network corresponding to the first RAT after checking that the UE does not need to stay in the second network. In some embodiments, the first RAT comprises Long-Term Evolution (LTE). In some embodiments, the second RAT comprises at least one of a Code Division Multiple Access (CDMA) RAT, a Global System for Mobile (GSM) RAT, and a Universal Mobile Telecommunication System (UMTS) RAT. In some embodiments, before determining that the connection has been released, the method further comprises: initiating a circuit switched fallback (CSFB) establishment procedure with the second network; and determining that a connection management (CM) message is not transmitted by the second network.

In a preferred embodiment, the invention is directed to a method for improving circuit-switched fallback for a user equipment (UE) in wireless communications system, wherein the UE is capable of communicating via first and second radio access technologies (RATs), comprising: determining that a connection has been released, wherein the connection is associated with a second network corresponding to the second RAT; starting a timer providing a period of time when the connection has been released; and stopping the timer after a condition is satisfied.

In some embodiments, the condition belongs to one of the following: the processor detects that a call is successfully connected: or the processor detects that the UE successfully goes back to a first network corresponding to the first RAT. In some embodiments, the call is a mobile terminating (MT) call or a mobile originating (MO) call. In some embodiments, the processor detects that the UE successfully goes back to the first network through a procedure,wherein the procedure a handover procedure, a cell change order procedure, a redirection procedure, or a cell reselection procedure. In some embodiments, the processor further executes the program code stored in the memory by: detecting that the timer has expired and the condition is not satisfied; checking whether the UE needs to stay in the second network after the timer has expired; and going back from the second net work to a first net work corresponding to the first RAT after checking that the UE does not need to stay in the second network. In some embodiments, the first RAT comprises Long-Term Evolution (LTE). In some embodiments, the second RAT comprises at least one of a Code Division Multiple Access (CDMA) RAT, a Global System for Mobile (GSM) RAT, and a Universal Mobile Telecommunication System (UMTS) RAT. In some embodiments, before determining that the connection has been released, the processor further executes the program code stored in the memory by: initiating a circuit switched fallback (CSFB) establishment procedure with the second network; and determining that a connection management (CM) message is not transmitted by the second network.

A detailed description s given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 illustrates a multi-cell, wireless communications system according to an embodiment of the present invention.

FIG. 2 illustrates an exemplary simplified architecture for enhanced packet service (EPS) LTE and 3GPP CS networks according to an embodiment of the present invention.

FIG. 3 is a functional block diagram of a communication apparatus according to an embodiment of the present invention

FIG. 4 is a simplified block diagram of the program code shown in FIG. 3 in accordance with one embodiment of the invention.

FIG. 5 illustrates a conventional call flow of CSFB when the UE fails to receive a mobile terminating (MT) call or when the UE fails to make a mobile originating (MO) call.

FIG. 6 illustrates a call flow of CSFB when a call the UE applies a timer for detecting whether a call is successfully connected according to an embodiment of the invention.

FIG. 7 illustrates a call flow 700 of CSFB when the UE applies a timer for detecting whether the UE successfully goes back to the PS LTE network according to an embodiment of the invention.

FIG. 8 illustrates a call flow 800 of CSFB when a timer expires according to an embodiment of the invention.

FIG. 9 is a flow chart 900 of a process illustrating the method for improving circuit-switched fallback for a user equipment (UE) according to an embodiment of the invention with reference to the call flows in FIG. 6-7 and the communication apparatus in FIG. 3.

FIG. 10 is a flow chart 1000 of a process illustrating the method for improving circuit-switched fallback for a UE according to an embodiment of the invention with reference to the call flow in FIG. 8 and the communication apparatus in FIG. 3.

### DETAILED DESCRIPTION OF THE INVENTION

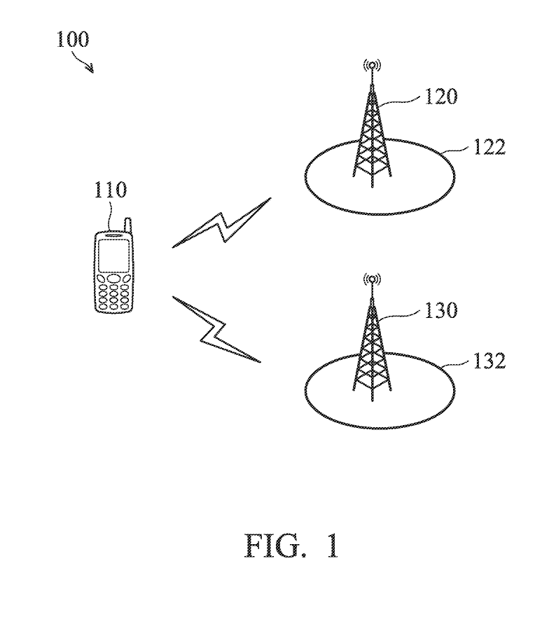

Several exemplary embodiments of the present disclosure are described with reference to FIGS. 1 through 10, which generally relate to a method and an apparatus for improving Circuit-switched fallback (CSFB). It should be understood that the following disclosure provides various embodiments as examples for implementing different features of the present disclosure. Specific examples of components and arrangements are described in the following to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various described embodiments and/or configurations.

The exemplary wireless communications systems and devices described below employ a wireless communications system, supporting a broadcast service. Wireless communications systems are widely deployed to provide various types of communication such as voice, data, and so on. These systems may be based on code division multiple access (CDMA), time division multiple access (TDMA), orthogonal frequency division multiple access (OFDMA), 3GPP LTE (Long Term Evolution) wireless access, 3GPP LTE-A or LTE-Advanced (Long Term Evolution Advanced), 3GPP2 UN IB (Ultra. Mobile Broadband), Wi)Max, or some other modulation techniques.

FIG. 1 illustrates a multi-cell, wireless communications system 100 according to an embodiment of the present invention. As shown in FIG. 1, the system 100 can include at least one base station (NodeB, eNodeB, access point, etc.) 120 and 130 each of which can include capable of communicating via one or more antennas (not shown) with a communications apparatus 110. The base station 120 and 130 may provide a cellular region (cell) 122 and 132, respectively. Each cell 122 or 132 can be configured under a different communication protocol (LTE, UTICA, CDMA2000, WiMAX, etc or two or more cells can be configured under the same communication protocol.

As shown in FIG. 1, the communications apparatus 110 can be associated with, or camped on, the cell 122, which might be an Long Term Evolution (LTE) cell, and can be actively communicating via the base station 120 or can be in an idle mode within the cell 132. The communications apparatus 110 may be a mobile device and be moving in a direction away from and/or towards the base station 120 and/or 130. In certain cases, it may be that either the cell 122 or 132 is better suited for communicating with the communications apparatus 110. To facilitate a switch between the cells, the communications apparatus 110 may periodically measure the strength of surrounding cells and/or periodically perform a cell reselection procedure. In certain cases, it may be that the camped-on cell 122 is a PS LTE cell, capable of data connectivity with the communications apparatus 110, and that cell 132 is a 3GPP CS cell (e.g., any 3GPP 2G/3G cell, such as GSM, TDSCDMA, WCDMA, CDMA, and so on), capable of voice connectivity with the communications apparatus 110.

Circuit-switched fallback (CSFB) is a technique to deliver voice-services to a communications apparatus, when the communications apparatus is camped in a PS LTE network. This may be required when the PS LTE network does not support voice services natively. The PS LTE network and a 3GPP CS network (e.g., UNITS or GSM) may be connected using a tunnel interface. The communications apparatus 110 may register with the 3GPP CS network while on the PS LTE network by exchanging messages with the 3GPP CS network over the tunnel interface. If a user makes a mobile originating (MO) call, or receives a mobile terminating (MT) call, the communications apparatus 110 may inform the PS UE network that the communications apparatus 110 is leaving for the call by initiating a CSFB call establishment procedure.

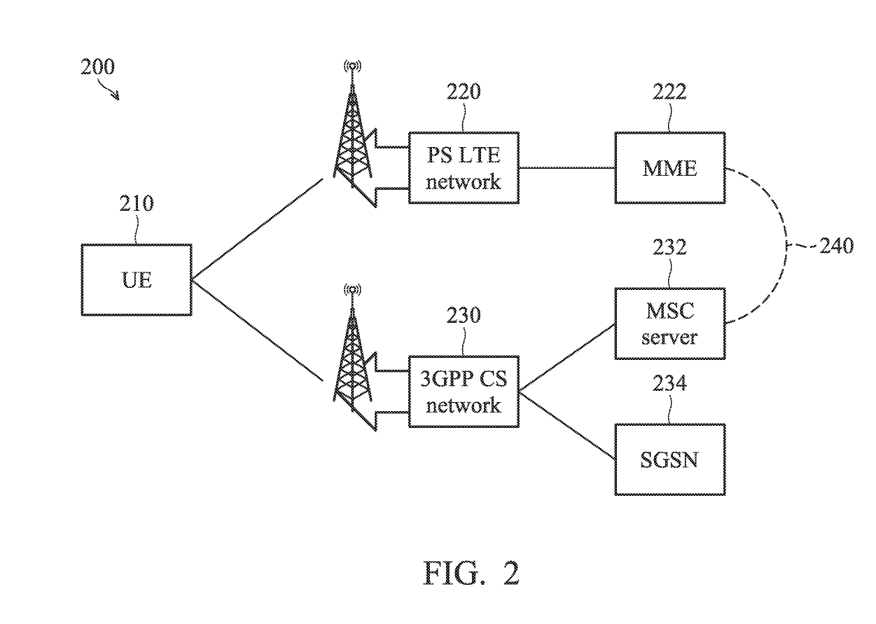

FIG. 2 illustrates an exemplary simplified architecture 200 for enhanced packet service (EPS) LTE and 3GPP CS networks according to an embodiment of the present invention. As shown in FIG. 2, a PS LTE network 220 and a 3GPP CS network 230 can co-exist between one or more user equipment (UE) 210 and the common core network(s). A mobility management entity (MME) 222 may communicate with the PS LTE network 220 and may perform various functions such as mobility management, bearer management, distribution of paging messages, security control, authentication, gateway selection, etc. A serving general packet radio service (GPRS) support node (SGSN) 234 facilitates services while in 3GPP CS data mode. A mobile switching center (MSC) server 232 may communicate with the 3GPP CS network 230 and may support voice services, provide routing for circuit-switched calls, and perform mobility management for UEs located within the area served by the MSC server 232. The MSC server 232 connects to the carrier's telephony network (not shown in FIG. 2). To support CSFB signaling and short message service (SMS) transfer for LTE devices, the MME 222 can connect to the MSC server 232 via an interface 240, which can enable the UE 210 to be both CS and PS registered. The interface 240 can also enable the delivery of CS pages and the SMS via the LTE access, without having the UE leave LTE.

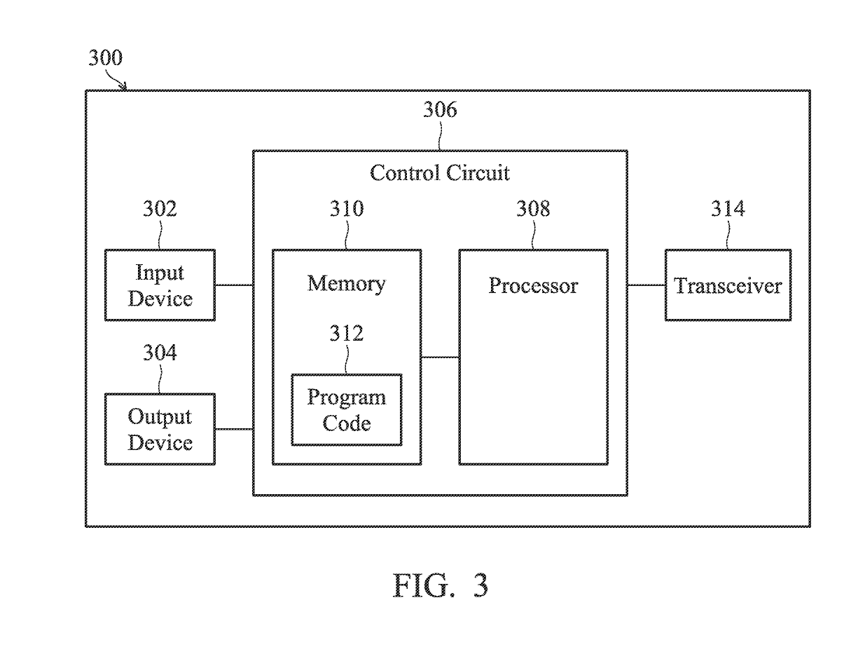

FIG. 3 is a functional block diagram of communication apparatus according to an embodiment of the present invention. As shown in FIG. 3, the communication apparatus 300 in a wireless communications system can be utilized for realizing the communications apparatus 110 in FIG. 1 or the UE 210 in FIG. 2. The communication apparatus 300 may include an input device 302, an output device 304, a control circuit 306, a processor 308 (which may be referred to as a central processor unit (CPU)), a memory 310, a program code 312, and a transceiver 314. The control circuit 306 executes the program code 312 in the memory 310 through the processor 308, thereby controlling the operation of the communications apparatus 300. The communications apparatus 300 can receive signals input by a user through the input device 302, such as a keyboard or keypad, and can output images and sounds through the output device 304, such as a monitor or speakers. The transceiver 314 is used to receive and transmit wireless signals, delivering received signals to the control circuit 306, and outputting signals generated by the control circuit 306 wirelessly.

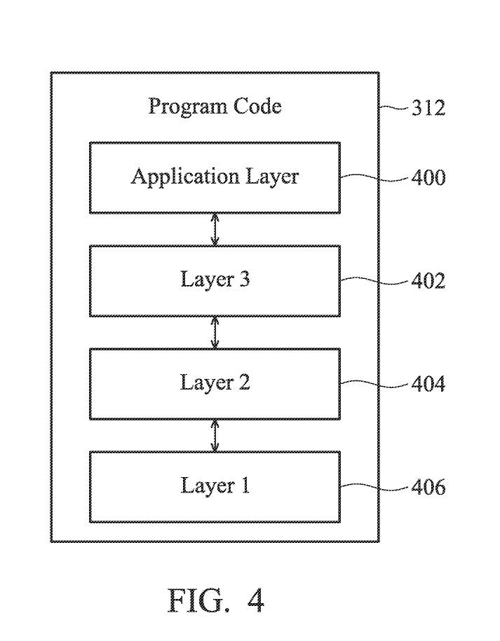

FIG. 4 is a simplified block diagram of the program code 312 shown in FIG. 3 in accordance with one embodiment of the invention. In this embodiment, the program code 312 includes an application layer 400, a Layer 3 portion 402, a Layer 2 portion 404, and a Layer 1 portion 406. The Layer 3 portion 402 generally performs radio resource control. The Layer 2 portion 404 generally performs link control. The Layer 1 portion 406 generally performs physical connections.

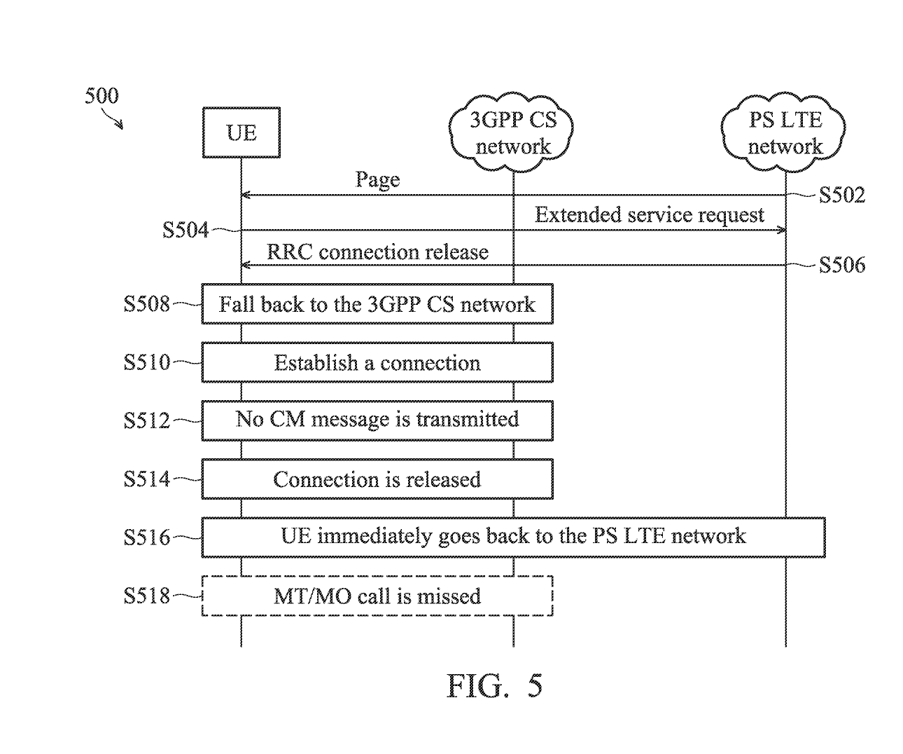

FIG. 5 illustrates a conventional call flow 500 of CSFB when the UE fails to receive a mobile terminating (MT) call or when the UE fails to make a mobile originating MO) call. With the default LTE data network connection in operation, the MT incoming call to the UE) CS voice call may originate at a telephony network. Then, via the MSC server, the interface and the MME, a page can be triggered through the PS LTE network to the UE in step S502. A MO (i.e., outgoing call from the UE) call origination can follow the same general transition through the PS LTE network, the MME, the interface and the MSC server, except that paging is not needed.

After receiving the MT CS voice call page or initiating MO CS voice call, the CSFB can be initiated at the UE, with the UE sending an extended service request (ESR) to the PS LTE network in step S504. Next, the UE receives a radio resource control (RRC) connection release message in response to the ESR from the PS LTE network in step S506 before transitioning to the 3GPP CS network. After the successful messaging, the UE initiates a circuit switched fallback (CSFB) establishment procedure to fall back to the 3GPP CS network in step S508. Then, the UE establishes a connection with the 3GPP CS network in step S510 and waits for a connection management (CM) message transmitted from the 3GPP CS network. However, after the UE does not receive the CM message from the 3GPP CS network in step S512 (in other words, no CM message is transmitted from the 3GPP CS network), the connection is released in step S514.

Conventionally, upon the connection being released, the UE may immediately goes back from the 3GPP CS network to the PS LTE network in step S516. However, since the UE directly returns to the PS LTE network, the MT/MO call is missed in step S515 with the dotted line. In other words, the MT/MO call cannot be connected with the 3GPP CS network.

For some embodiments of the present invention, when the connection has been released, the UE may start a timer providing a period of time for waiting for setting up the MT/MO call or waiting for going back to the PS LTE network. Therefore, a continuous ping-pong effect can be effectively avoided.

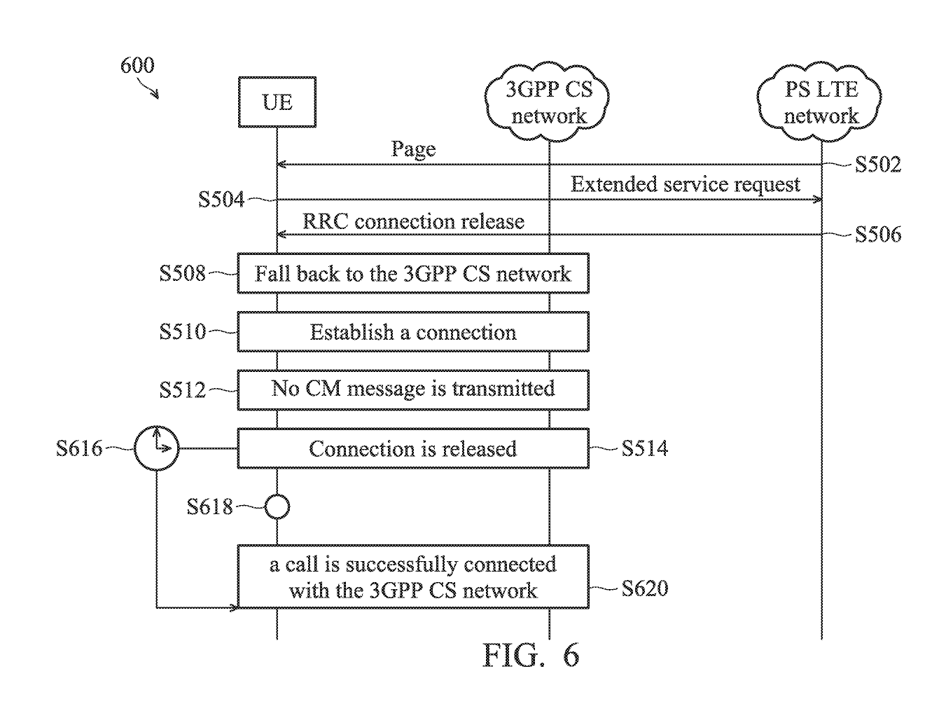

FIG. 6 illustrates a call flow of CSFB when a UE applies a timer for detecting whether a call is successfully connected according to an embodiment of the invention. In FIG. 6, those process steps of S502˜S514 which are the same as the respective counterparts of the call flow of FIG. 5 are indicated by the same reference numerals as in FIG. 5 and a description thereof is omitted. When the UE determines that the connection has been released in step S514, the UE starts a timer providing a period of time in step S616. Then, the UE detects whether a call is successfully connected with the 3GPP CS network before the timer expires in step S618, wherein the call can be a mobile terminating (MT) call or a mobile originating (MO) call. When the UE detects that the call is successfully connected with the 3GPP CS network in step S620, the UE can stop the timer.

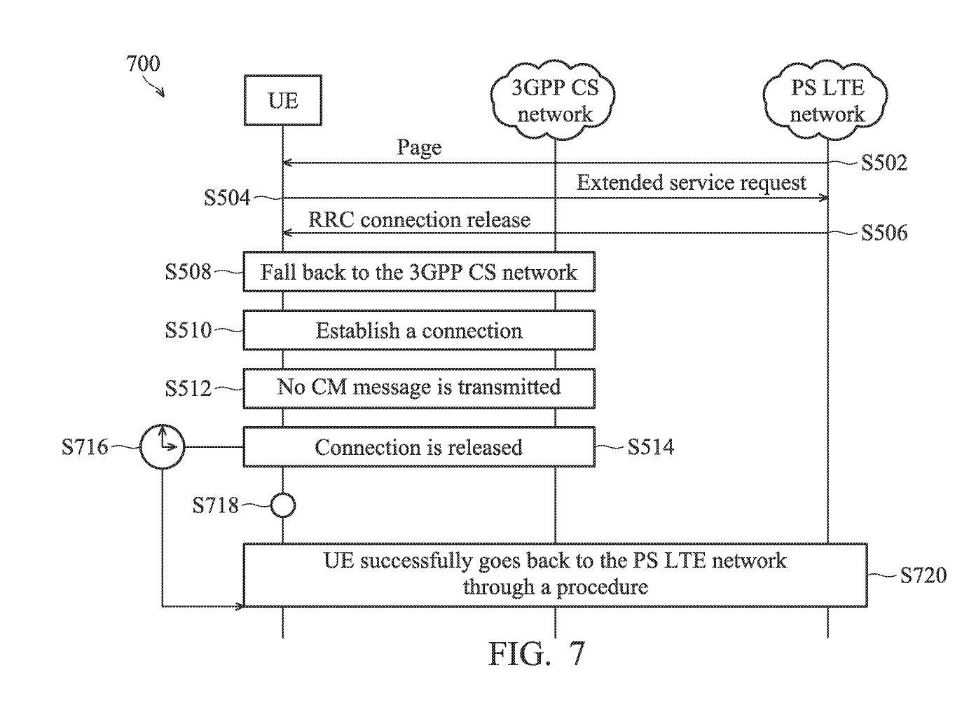

FIG. 7 illustrates a call flow 700 of CSFB when the UE applies a timer for detecting whether the UE successfully goes back to the PS LTE network according to an embodiment of the invention. Similarly, in FIG. 7, those process steps of S502˜S514 which are the same as the respective counterparts of the call flow of FIG. 5 are indicated by the same reference numerals as in FIG. 5 and a description thereof is omitted. When the UE determines that the connection has been released in step S514, the UE starts a timer providing a period of time in step S716. Then, the UE detects whether the UE successfully goes back to the PS LTE network before the timer expires in step S718. When the UE detects that the UE successfully goes back to the PS LTE network through a procedure in step S720, the UE can stop the timer. In the embodiment, the procedure can be a handover procedure, a cell change order procedure, a redirection procedure, or a cell reselection procedure.

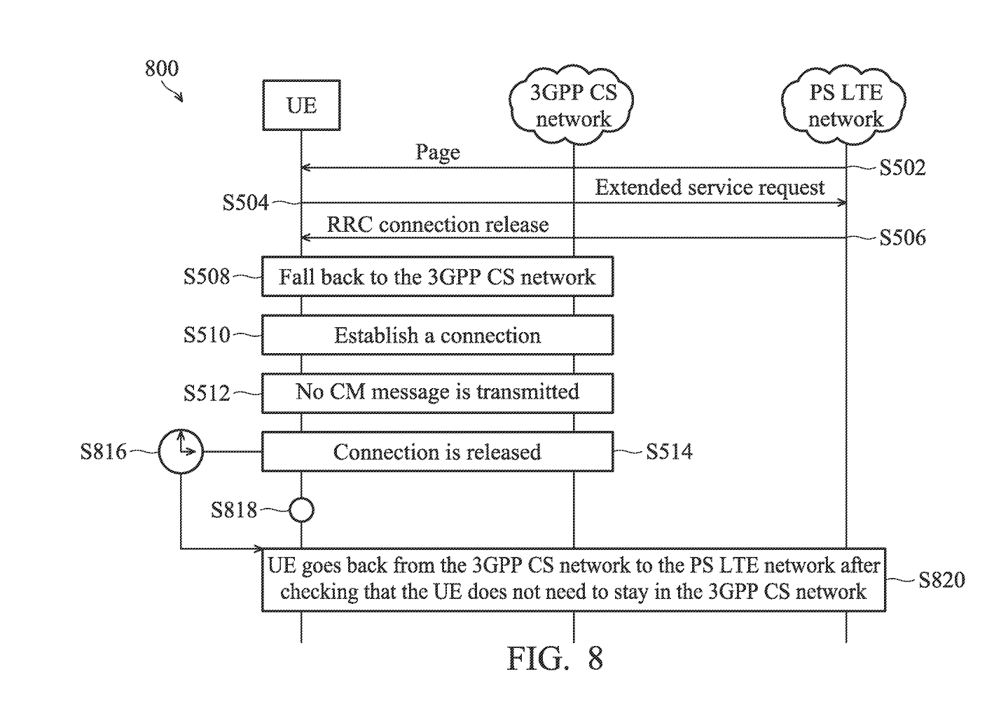

FIG. 8 illustrates a call flow 800 of CSFB when a timer expires according to an embodiment of the invention. Similarly, in FIG. 5, those process steps of S502˜S514 which are the same as the respective counterparts of the call flow of FIG. 5 are indicated by the same reference numerals as in FIG. 5 and a description thereof is omitted. When the UE determines that the connection has been released in step S514, the UE starts a timer providing a period of time in step S816. Then, the UE detects whether a call is successfully connected with the 3GPP CS network or the UE successfully goes back to the PS LTE network before the timer expires in step S818. When the UE detects that no call is successfully connected with the 3GPP CS network or the UE does not successfully go back to the PS LTE network before the timer has expired, the UE checks whether the UE needs to stay in the 3GPP CS network. After checking that the UE does not need to stay in the 3GPP CS network, the UE can go back from the 3GPP CS' network to the PS LTE network in step S820.

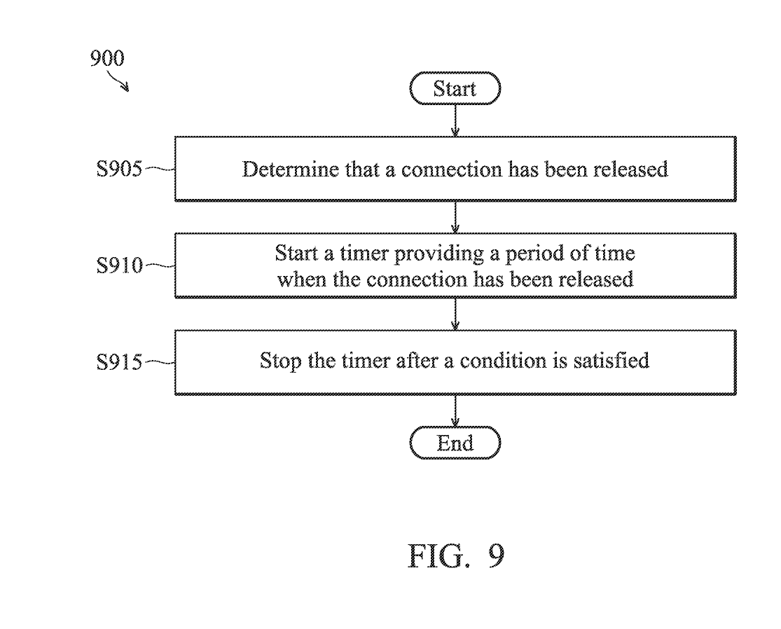

FIG. 9 is a flow chart 900 of a process illustrating the method for improving circuit-switched fallback for a user equipment (UE) according to an embodiment of the invention with reference to the call flows in FIG. 6˜7 and the communication apparatus in FIG. 3. In the embodiment, the UE is capable of communicating with a first network and a second network via first and second radio access technologies (RATs), respectively. It should be noted that the first network may be referred to as the PS LTE network in FIG. 6 and the first RAT may comprise Long-Term Evolution (LTE). The second network may be referred to as the 3GPP CS network in FIG. 6 and the second RAT comprises at least one of a Code Division Multiple Access (CDMA) RAT, a Global System for Mobile (GSM) RAT, and a Universal Mobile Telecommunication System (UNITS) RAT.

Referring to FIG. 9, in step S905, the processor determines that a connection has been released, wherein the connection associated with a second network corresponding to the second RAT. Next, in step S910, the processor starts a timer providing a period of time when the connection has been released. In step S915, the processor stops the timer after a condition is satisfied. When the processor determines that the UE receives the paging message (“Yes” in step S915), in step S920, the processor sets up a mobile terminating (MT) call. Otherwise, in step S925, the processor transmits a tracking area update (TAU) request to switch back from the second network to the first network corresponding to the first RAT after checking that the UE does not need to stay in the second network.

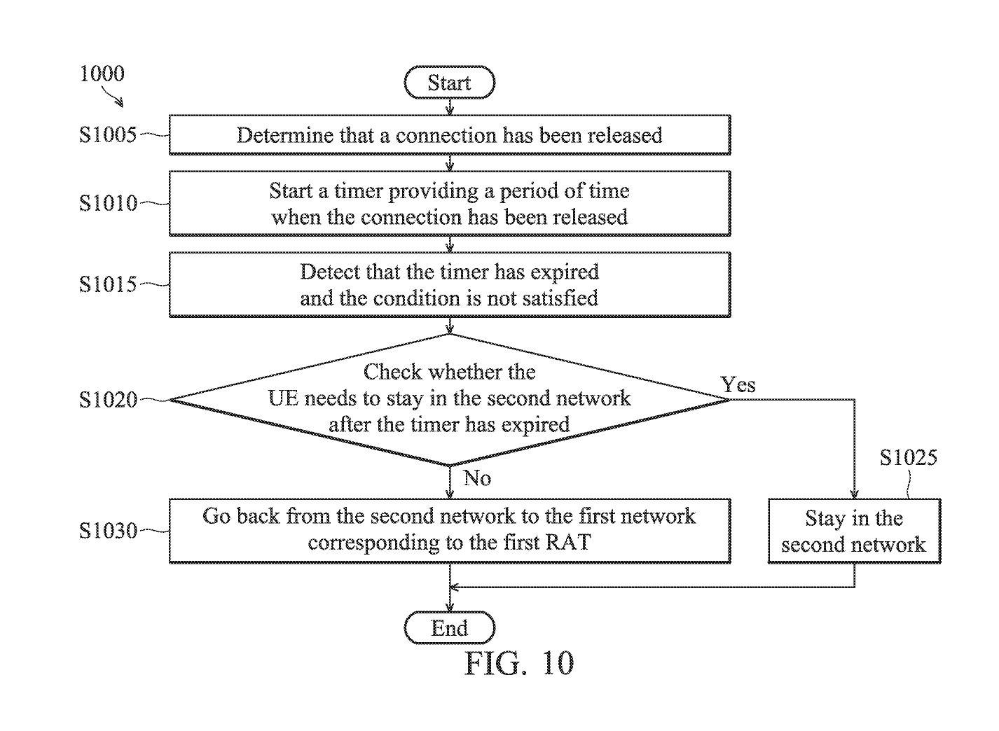

FIG. 10 is a flow chart 1000 of a process illustrating the method for improving circuit-switched fallback for a UE according to an embodiment of the invention with reference to the call flow in FIG. 8 and the communication apparatus in FIG. 3. In the embodiment, the UE is capable of communicating with a first network and a second network via first and second radio access technologies (RATs), respectively. It should be noted that the first network may be referred to as the PS LTE network in FIG. 7 and the first RAT may comprise Long-Term Evolution (LTE). The second network fray be referred to as the 3GPP CS network in FIG. 7, and the second RAT comprises at least one of a Code Division Multiple Access (CDMA) RAT, a Global System for Mobile (GSM) RAT, and a Universal Mobile Telecommunication System (UMTS) RAT.

Referring to FIG. 10, in step S1005, the processor determines that a connection has been released, wherein the connection is associated with the second network corresponding to the second RAT. Next, in step S1010, the processor starts a timer providing a period of time when the connection has been released. Then, in step S1015, the processor detects that timer has expired and the condition is not satisfied. In S1020, the processor checks whether the UE needs to stay in the second network after the timer has expired. When the processor determines that the UE needs to stay in the second network (“Yes” in step S1020), in step S1025, the UE stays in the second network. Otherwise, in step S1030, the UE goes back from the second network to the first network corresponding to the first RAT after checking that the UE does not need to stay in the second network.

In addition, the processor 308 can execute the program code 312 to perform all of the above-described actions and steps or others described herein.

As described above, the present invention can prevent that the network does not transmit a MT call paging message or the UE does not set up a MO call before the UE returns to the PS LTE network directly. Therefore, continuous a ping-pong effect can be effectively avoided to improve user experience.

Use of ordinal terms such as “first”, “second”, etc., in the claims to modify a claim clement does not by itself connote any priority, precedence, or order of one claim element over another or the temporal order in which acts of a method are performed, but are used merely as labels to distinguish one claim clement having a certain name from another element having the same name (but for use of the ordinal term) to distinguish the claim elements.

Various aspects of the disclosure have been described above. It should be apparent at the teachings herein may be embodied in a wide variety of forms and that any specific structure, function, or both being disclosed herein merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using another structure, functionality, or structure and functionality in addition to or other than one or more of the aspects set forth herein. As an example of some of the above concepts, in some aspects concurrent channels may be established based on pulse repetition frequencies. In some aspects concurrent channels may be established based on pulse position or offsets. In some aspects concurrent channels may be established based on time hopping sequences. In some aspects concurrent channels may be established based on pulse repetition frequencies, pulse positions or offsets, and time hopping sequences.

Those with skill in the art will understand that information and signals may be represented using any of a variety of different technologies and techniques. For example, data instructions, commands, information, signals, bits, symbols, and chips that may be referenced throughout the above description may be represented by voltages, currents, electromagnetic waves, magnetic fields or particles, optical fields or particles, or any combination thereof.

Those with skill in the art will further appreciate that the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described abode generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

In addition, the various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It should be understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two. A software are module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such that the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects any suitable computer-program product may comprise a computer-readable medium comprising codes relating to one or more of the aspects of the disclosure. In some aspects a computer program product may comprise packaging materials.

While the invention has been described by way of example and in terms of the preferred embodiments, it is to be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

1. A method for improving circuit-switched fallback for a user equipment (UE) in a wireless communications system, wherein the UE is capable of communicating via first and second radio access technologies (RATs), comprising:
determining that a connection has been released, wherein the connection is associated with a second network corresponding to the second RAT;
starting a timer providing a period of time when the connection has been released; and
stopping the timer after a condition is satisfied.

2. The method as claimed in claim 1, wherein the condition belongs to one of the following:
detecting that a call is successfully connected; or
detecting that the UE successfully goes back to a first network corresponding to the first RAT.

3. The method as claimed in claim 2, wherein the call is a mobile terminating (MT) call or a mobile originating (MO) call.

4. The method as claimed in claim 2, wherein detecting that the UE successfully goes back to the first network is performed through a procedure, the procedure is a handover procedure, a cell change order procedure, a redirection procedure, or a cell reselection procedure.

5. The method as claimed in claim 1, wherein the method further comprises:
detecting that the timer has expired and the condition is not satisfied;
checking whether the UE needs to stay in the second network after the timer has expired; and
going back from the second network to a first network corresponding to the first RAT after checking that the UE does not need to stay in the second network.

6. The method as claimed in claim 1, wherein the first RAT comprises Long-Term Evolution (LTE).

7. The method as claimed in claim 1, wherein the second RAT comprises at least one of a Code Division Multiple Access (CDMA) RAT, a Global System for Mobile (GSM) RAT, and a Universal Mobile Telecommunication System (UMTS) RAT.

8. The method as claimed in claim 1, wherein before determining that the connection has been released, the method further comprises:
initiating a circuit switched fallback (CSFB) establishment procedure with the second network; and
determining that a connection management (CM) message is not transmitted by the second network.

9. A communications apparatus for improving circuit-switched fallback, wherein the communications apparatus is capable of communicating via first and second radio access technologies (RATs), comprising:
a control circuit;
a processor installed in the control circuit; and
a memory installed in the control circuit and operatively coupled to the processor;
wherein the processor is configured to execute a program code stored in the memory by:
determining that a connection has been released, wherein the connection is associated with a second network corresponding to the second RAT;
starting a timer providing a period of time when the connection has been released; and
stopping the timer after a condition is satisfied.

10. The communications apparatus as claimed in claim 9, wherein the condition belongs to one of the following:
the processor detects that a call is successfully connected; or
the processor detects that the UE successfully goes back to a first network corresponding to the first RAT.

11. The communications apparatus as claimed in claim 10, wherein the call is a mobile terminating (MT) call or a mobile originating (MO) call.

12. The communications apparatus as claimed in claim 10, wherein the processor detects that the UE successfully goes back to the first network through a procedure, the procedure is a handover procedure, a cell change order procedure, a redirection procedure, or a cell reselection procedure.

13. The communications apparatus as claimed in claim 9, wherein the processor further executes the program code stored in the memory by:
detecting that the timer has expired and the condition is not satisfied;
checking whether the UE needs to stay in the second network after the timer has expired; and
going back from the second network to a first network corresponding to the first RAT after checking that the UE does not need to stay in the second network.

14. The communications apparatus as claimed in claim 9, wherein the first RAT comprises Long-Term Evolution (LTE).

15. The communications apparatus as claimed in claim 9, wherein the second RAT comprises at least one of a Code Division Multiple Access (CDMA) RAT, a Global System for Mobile (GSM) RAT, and a Universal Mobile Telecommunication System (UMTS) RAT.

16. The communications apparatus as claimed in claim 11, wherein before determining that the connection has been released, the processor further executes the program code stored in the memory by:
initiating a circuit switched fallback (CSFB) establishment procedure with the second network; and
determining that a connection management (CM) message is not transmitted by the second network.
receiving downlink (DL) data from a DL channel during a transmission time interval (TTI);
attempting to decode the received DL data before receiving all DL data of the TTI; and
transmitting an early termination indicator (ETI) in an uplink (UL) slot of a UL radio frame to terminate transmission of the DL data during the TTI based on a successful decode,
wherein at least one symbol of the UL slot is replaced by the ETI, and the symbol replaced by the EIT is the TFCI symbol.
